(19) United States
(12) Patent Application Publication
(10) Pub. No.: US 2019/0130889 A1
(43) Pub. Date: May 2, 2019

(54) DRONE-BASED INTERACTIVE AND ACTIVE AUDIO SYSTEM

(71) Applicant: TEAL DRONES, INC., Salt Lake City, UT (US)

(72) Inventors: George Michael Matus, JR., Salt Lake City, UT (US); Shawn Ray Nageli, South Jordan, UT (US)

(21) Appl. No.: 16/170,877

(22) Filed: Oct. 25, 2018

Related U.S. Application Data
(60) Provisional application No. 62/577,337, filed on Oct. 26, 2017.

(51) Int. Cl. G10K 11/178; H04R 5/027; H04R 5/02; B64C 39/02; G06F 3/16

(52) U.S. Cl. CPC G10K 11/178; H04R 5/027; H04R 5/02; B64C 39/024; B64C 2201/14; G10K 2210/1281; H04R 2499/13; B64C 2201/108; G06F 3/167

(57) ABSTRACT

A drone-based audio system comprising a microphone mounted to a drone body for receiving environmental sound information. The drone-based audio system additionally comprising a processing unit configured to analyze the environmental sound information and calculate active noise cancellation information. The drone-based audio system further comprising a speaker mounted to the drone body for emitting the active noise cancellation information.

### CROSS-REFERENCE TO RELATED APPLICATIONS

This application claims the benefit of and priority to U.S. Provisional Patent Application Ser. No. 62/577,337 filed on Oct. 26, 2017, entitled “DRONE-BASED INTERACTIVE AND ACTIVE AUDIO SYSTEM”.

### BACKGROUND

After being used in military application for some time, so called “drones” have experienced a significant increase in public use and interest in recent years. The proposed uses for drones have rapidly expanded to include everything from package delivery to mapping and surveillance. The wide-ranging uses for drones have also created a wide assortment of different drone configurations and models. For example, some drones are physically better suited to travelling at high speed, while other drones are physically better suited for travelling long distances.

Conventional drones typically fall within two different categories: fixed-wing drones and rotor-based drones. Rotor-based drones may comprise any number of different rotors, but a common rotor configuration comprises four separate rotors. Rotor-based drones provide several benefits over fixed-wing drones. For example, rotor-based drones do not require a runway to take-off and land. Additionally, rotor-based drones can hover over a position, and in general are typically more maneuverable. Also, rotor-based drones are significantly more capable of flying within buildings and other structures.

Despite these advantages, several technical limitations have slowed the wide-spread use and adoption of rotor-based drones. One such technical limitation relates to the environmental impact on members of public in relation to flying rotor-based drones. For example, rotor-based drones emit a loud and disruptive buzzing sound that most users and bystanders find startling and irritating. The increased demand for rotor-based drones has presented a need for improved drone acoustics.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein comprise systems, methods, and apparatus configured to improve rotor-based drone acoustics. In particular, disclosed embodiments comprise a rotor-based remote flying vehicle that includes one or more microphones capable of receiving environmental sound information. The rotor-based remote flying vehicle may also include one of more processing units capable of analyzing the received environmental sound information and calculating active noise cancellation information. Finally, the rotor-based remote flying vehicle may include one or more speakers configured to emit the calculated active noise cancellation information that diminishes the received environmental sound information.

Disclosed embodiments include a drone-based audio system comprising a microphone mounted to a drone body for receiving environmental sound information. The drone-based audio system additionally comprising a processing unit configured to analyze the environmental sound information and calculate active noise cancellation information. The drone-based audio system further comprising a speaker mounted to the drone body for emitting the active noise cancellation information.

Additionally, disclosed embodiments include a method for modifying the sound emitted by a drone in at least one direction. The method may comprise receiving, with a microphone mounted to a drone, environmental sound information. Additionally, the method may comprise calculating, from the environmental sound information, active noise cancellation information. Further, the method may comprise emitting, from a speaker mounted to the drone, the active noise cancellation information.

Further, disclosed embodiments include a drone-based audio system comprising a drone body and one or more motors attached to the drone body. The drone-based audio system also comprises a microphone attached to the drone body for receiving environmental sound information. A processing unit may be attached to the drone body. The processing unit can be configured to analyze environmental sound information and calculate active noise cancellation information based on the environmental sound information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings which are listed below.

FIG. 1 illustrates an embodiment of a drone.

FIG. 2 illustrates an embodiment of a propeller and drone arm.

FIG. 3 illustrates a flowchart comprising steps in an embodiment of a method for actively and interactively cancelling environmental noise.

### DETAILED DESCRIPTION

Embodiments disclosed herein comprise systems, methods, and apparatus configured to improve rotor-based drone acoustics. In particular, disclosed embodiments comprise a rotor-based remote flying vehicle that includes one or more microphones capable of receiving environmental sound information. The rotor-based remote flying vehicle may also include one of more processing units capable of analyzing the received environmental sound information and calculating active noise cancellation information. Finally, the rotor-based remote flying vehicle may include one or more speakers configured to emit the calculated active noise cancellation information that diminishes the received environmental sound information.

In the following disclosure, various exemplary embodiments of the present invention are recited. One will understand that these examples are provided only for the sake of clarity and explanation and do not limit or otherwise confine the invention to the disclosed examples. Additionally, one or more of the following examples is provided with respect to a “drone.” One will understand that the usage of a “drone” is merely for the sake of clarity and that the present invention applies equally to all rotor-based remote flying vehicle platforms regardless of the number of rotors.

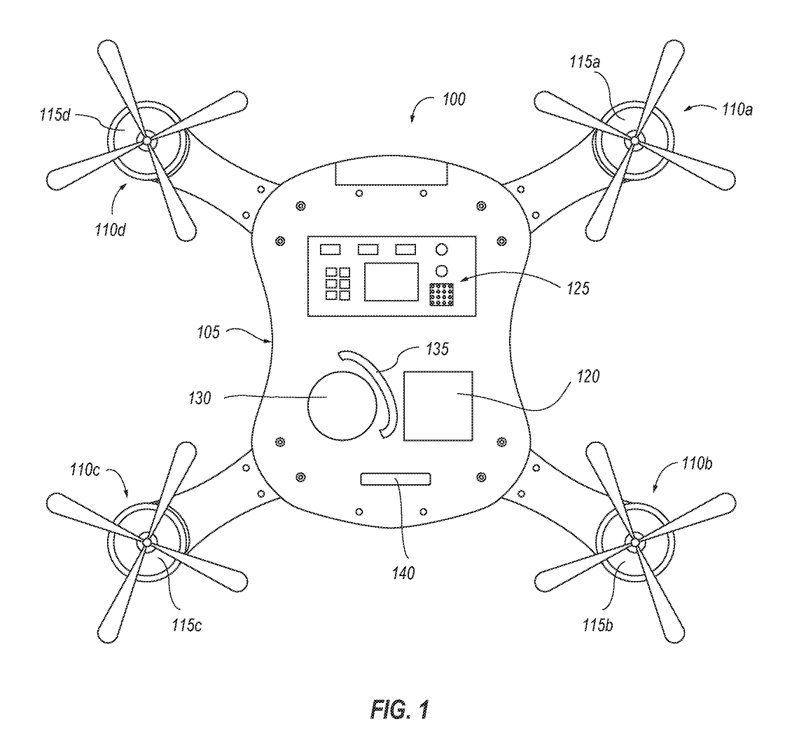

Turning to the figures, FIG. 1 illustrates an exemplary drone 100 that comprises a vehicle body 105 and multiple arms 110(a-d) attached to a vehicle body 105. Additionally, as illustrated in FIG. 1, the arms 110(a-d) each comprise a motor 115(a-d). Notably, in some embodiments, the arms 110(a-d) comprise modular arms, such that different types of arms (e.g., arms of different lengths, arms of different materials, arms having different types of propellers, and so forth) are selectively removable and reconfigurable.

The depicted drone 100 also comprises a microphone 120 mounted to the vehicle body 105. The microphone 120 may be positioned on top of the vehicle body 105 such that it is pointing upwards when the drone 100 is in flight. Additionally or alternatively, the microphone 120 may be positioned on the bottom of the vehicle body 105 such that it is pointing downwards when the drone 100 is in flight. As such, the vehicle body 105 may comprise a microphone 120 on top of the vehicle body 105, on the bottom of the vehicle body 105, or on both the top and the bottom of the vehicle body 105.

In at least one embodiment, the microphone 120 is configured to receive environmental sound information. The environmental sound information may be noise produced from the drone 100, a voice command of the user, or any ambient noise in the vicinity of the drone 100. The microphone 120 communicates the received environment sound information to a processing unit 125 mounted to, or otherwise integrated with, the vehicle body 105. The processing unit 125 can be configured to analyze the environmental sound information and calculate active noise cancellation information. As used herein, active noise cancellation information comprises information necessary for a speaker 130 to create a responsive sound wave that diminishes the sound described by the environmental sound information. In at least one embodiment, the active noise cancellation information comprises information necessary to create a sound wave that has the same amplitude as the sound described by the environmental sound information but an inverted phase from the sound described by the environmental sound information.

A speaker 130 is shown mounted to the vehicle body 105, which can be configured to emit the calculated active noise cancellation information to diminish environmental sound. The location, size, and general configuration of the speaker 130, microphone 120, and processor 125 are provided for the sake of example and may be otherwise configured. For example, the speaker 130 and microphone 120 may be located on the bottom of the drone body 105 such that the noise cancellation is directed below the drone and towards the more likely location of a user.

In at least one embodiment, the microphone 120 is be configured to detect the sound frequency associated with the rotational speed or one or more motors 115(a-d). The processing unit 125 analyzes the sound frequency information and, based upon the analysis, adjusts the rotational speed and/or phase of at least one motor (e.g., 115a) until the motor 115a reaches a desired speed and/or phase. By making these adjustments, the processing unit 125 causes the one or more motors 115(a-d) to be destructively out-of-phase with each other such that the noise from the motors 115(a-d) themselves functions to at least partially cancel itself out.

In at least one additional or alternative embodiment, the processing unit 125 is configured to analyze environmental sound information received from the microphone 120 and cause the drone 100 to react as a result of the analyzed environmental sound information. For example, the received environmental sound information could be voice instructions from the user. The voice instructions may comprise directional instructions.

In at least one embodiment, the processing unit 125 is further configured to receive mechanical-performance information directly from one or more motors 115(a-d) via a feedback loop. For example, the mechanical-performance information may comprise rotations per minutes of the respective motors. Based upon the mechanical-performance information, the processing unit 125 calculates active noise cancellation information that diminishes sound produced by the one or more motors 115(a-d). In at least one embodiment, the active noise cancellation information can be emitted by the speaker 130. Additionally, the active noise cancellation information can be used to adjust the speed and/or phase of the motors, as described above.

Additionally, in at least one embodiment, the processing unit 125 uses the active noise cancellation information to filter out environmental sounds received by its microphone 120. For example, the drone 100 may be configured to receive voice commands from a user. Due to the amount of noise generated by the motors 115(a-d) and the general environmental noise, it may be difficult for the processing unit 125 to understand the vocal commands. In at least one embodiment, the processing unit 125 filters the input received from the microphone 120 using the active noise cancellation information. Applying the active noise cancellation information may allow the processing unit 125 to more readily detect and interpret voice commands from the user. Because the processing unit 125 can filter out the portion of the received environmental sound information that was produced from the one or more motors 115(a-d), the drone 100 can receive voice commands from the user even if the speaker 130 is not emitting active noise cancellation information.

In additional or alternative embodiments, the processing unit 125 is configured to provide the user with updates, which can be emitted by the speaker 130. When such information is emitted, the processing unit 125 does not calculate the emitted information into the active noise cancellation information. As such, the active noise cancellation information is focused on diminishing the noise of the motors 115(a-d) and environmental noise, which makes it easier for the user to hear the emitted noise.

The user, by communicating with the processing unit 125 (e.g., via radio, Bluetooth, Wi-Fi, etc.) may also control the amount and/or direction of active noise cancellation information emitted by the speaker 130. The processing unit 125 may be pre-programmed or pre-trained with respect to received environmental sound information data. Additionally, the processing unit 125 may employ machine learning, such that the processing unit 125 can continually improve its ability to improve the acoustics of the drone 100, based on previous experiences.

FIG. 1 also shows a shield 135 surrounding part of the speaker 130. The shield 135 can be configured to directionally adjust the active noise cancellation information emitted by the speaker. The shield 135 may be configured to rotate around the speaker 130 and/or expand to cover a portion of the speaker 130. In an alternative or additional embodiment, the speaker 130 itself is configured to directionally adjust the emitted active noise cancellation information. For example, in at least one embodiment, the drone 100 detects a location of the user using GPS coordinates associated with a controller for controlling the drone, vision tracking of the user, voice localization, or any other means for tracking the user's location. The shield 135 may then be positioned to direct the active noise cancellation information towards the user. One will appreciate that the shield 135 is provided only for the sake of example and explanation. In additional or alternative embodiments, the shield 135 may function as, or with, an actuator to tilt the speaker 130.

A sensor 140 mounted to the vehicle body 105 is also shown in FIG. 1. The sensor 140 may be configured to detect the presence of an audio-reflective surface. For example, the sensor 140 may comprise a sonar, a laser distance measuring device, a LIDAR, a camera, or any other sensor capable of measuring a identifying a surface external to the drone 100. When the sensor 140 detects an audio-reflective surface, the processing unit 125 may be configured to calculate audio-reflection noise cancellation information. The audio-reflection noise cancellation information may be incorporated into the active noise cancellation information or may be kept separate. The speaker 130 may the emit the calculated audio-reflection noise cancellation information, thereby minimizing reflective noise. For example, the drone 100 may be flying close to a ceiling. The ceiling may reflect noise from the motors 115(a-d) down towards the user. In at least one embodiment, upon the sensor 140 detecting the ceiling, the processing unit 125 calculates active noise cancellation information that is configured to minimize or cancel the noise that is reflected from the ceiling and towards the user. The sensor 140 may also be configured to sense where the user is located and cause the speaker 130 and/or shield 135 to adjust the emitted noise cancellation information based on the location of the user.

The placement of the microphone 120, processing unit 125, speaker 130, shield 135, and sensor 140 on the vehicle body 105 of the drone 100 is not limited to that illustrated in FIG. 1. Further, while the vehicle body 105 of the drone 100 is shown only having one microphone 120, processing unit 125, speaker 130, shield 135, and sensor 140, additional or alternative embodiments have any number or combination of these accessories or any additional accessories.

The microphone 120, processing unit 125, speaker 130, shield 135, and sensor 140 may be mounted to the vehicle body 105 using any suitable means. For example, in at least one embodiment, the microphone 120, processing unit 125, speaker 130, shield 135, and/or sensor 140 are integrated within the vehicle body 105 during manufacturing. Alternatively, the microphone 120, processing unit 125, speaker 130, shield 135, and/or sensor 140 may be attached to the vehicle body 105 after manufacturing by the manufacturer or user. The manufacturer or user can attach the microphone 120, processing unit 125, speaker 130, shield 135, and/or sensor 140 to the vehicle body 105 using glue, tape, welding equipment, etc.

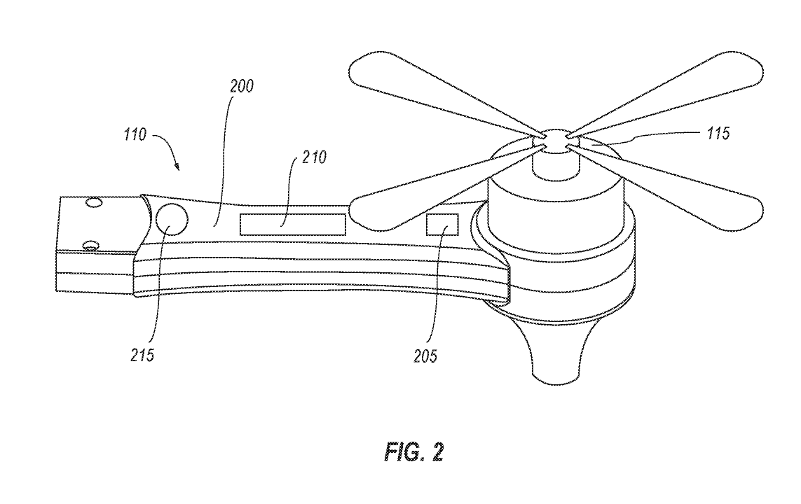

FIG. 2 illustrates an exemplary arm 110, which may include an arm body 200 and a motor 115. In at least some embodiments, the arm 110 has an arm-based microphone 205, arm-based processing unit 210, and arm-based speaker 215, which may be configured similarly to the microphone 120, processing unit 125, and speaker 130 mounted to the vehicle body 105. The arm-based accessories may be mounted to the arm 110 similarly to how the vehicle body-based accessories are mounted to the vehicle body 105. Notably, while the exemplary arm 110 shown in FIG. 2 has the arm-based microphone 205, arm-based processing unit 210, and arm-based speaker 215 mounted to the arm-body 200, in other embodiments, the arm-based microphone 205, arm-based processing unit 210, and arm-based speaker 215 are mounted on any area of the arm 110.

In at least one embodiment, the processing unit 125 mounted to the drone body 105 performs the noise cancellation processing for the arms. In contrast, in at least one embodiment, the arm-based processing unit 210 performs the processing. As such, a modular drone arm with noise cancelling capabilities, such as that shown in FIG. 2, can be added to a drone that does not have native processing capabilities for noise cancellation.

The arm-based microphone 205 may be configured to receive environmental sound information produced by the motor 115 on the arm 110. The arm-based processing unit 210 may be configured to analyze the environmental sound information produced by the motor 115 and calculate active noise cancellation information that diminishes the environmental sound information produced by the motor 115. The arm-based processing unit may alternatively or additionally be configured to receive mechanical-performance information from the motor 115 via the feedback loop and calculate active noise cancellation information that diminishes the environmental sound information produced by the motor 115. Finally, the arm-based speaker 215 may be configured to emit the calculated active noise cancellation information to diminish the environmental sound information produced by the motor 115.

The arm 110 may include all, some, or none of the arm-based accessories. Each of the four arms on a drone could also comprise a different combination of the arm-based accessories. For example, the drone 100 can have an arm-based microphone 205 on two of its arms 110, an arm-based speaker 215 on its other two arms 110, and no arm-based processing unit 210. Instead, the arm-based microphones 205 and arm-based speakers 215 can be configured to interact with the processing unit 125 mounted to the drone body. The arm 110 may also comprise additional accessories not shown in FIG. 2, such as an arm-based shield or arm-based sensor.

As stated above, one will understand that the depicted drone 100 is merely exemplary. Additional or alternate embodiments of the present invention may comprise rotor-based remote flight systems with less than four arms 110(a-d) or rotor-based remote flight systems with more than four arms 110(a-d). Additionally, various embodiments of the present invention may comprise different physical configurations, construction materials, proportions, and functional components. For instance, rotor-based remote flight platforms may comprise a mixture of components such as cameras, sonars, laser sights, GPS, various different communication systems, and other such variations. Accordingly, the principles described herein may be practiced using essentially any configuration of sensors with respect to any configuration of rotor-based flight systems.

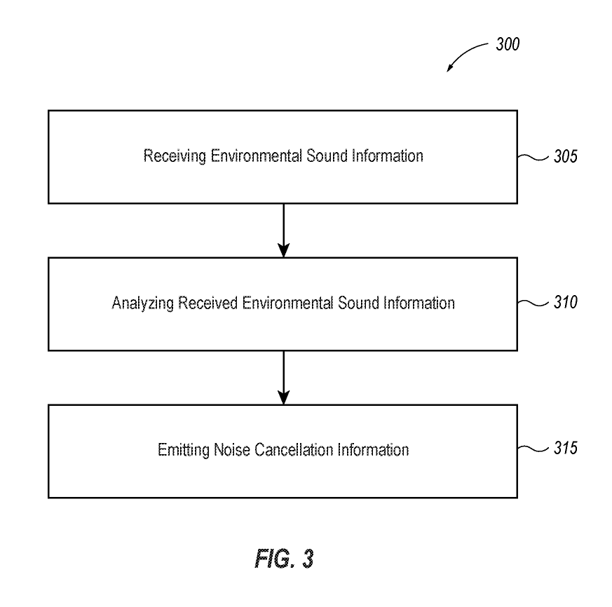

One will appreciate that embodiments disclosed herein can also be described in terms of flowcharts comprising one or more acts for accomplishing a particular result. For example, FIG. 3 and the corresponding text describe acts in various methods and systems for improving the acoustics of a drone 100. The method 300 is described with frequent reference to FIGS. 1 and 2.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

The method 300 includes an act 305 of receiving environmental sound information. For instance, the microphone 120 may receive environmental sound information that is produced by the drone 100, the user, and/or the environment of the drone 100. The method 300 may further include an act 310 of analyzing received environmental sound information. For example, the processing unit 125 may receive environmental sound information from the microphone 120, analyze the information, and calculate active noise cancellation information. Finally, the method 300 may also include an act 315 of emitting noise cancellation information. For instance, the speaker 130 can be configured to emit the calculated active noise cancellation information to diminish the environmental noise. By this, the acoustics of the drone 100 can be improved.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A drone-based audio system comprising:
a microphone mounted to a drone body for receiving environmental sound information;
a processing unit configured to analyze the environmental sound information and calculate active noise cancellation information; and
a speaker mounted to the drone body for emitting the active noise cancellation information.

2. The drone-based audio system of claim 1, further comprising a feedback loop between one or more motors and the processing unit.

3. The drone-based audio system of claim 2, wherein the processing unit is configured to receive mechanical-performance information from the one or more motors via the feedback loop and calculate active noise cancellation information based upon the mechanical-performance information.

4. The drone-based audio system of claim 1, wherein the one or more motors are mechanically configured to cancel out sound produced by one or more other motors.

5. The drone-based audio system of claim 1, wherein an amount of the active noise cancellation information emitted by the speaker is selectively controlled by a user.

6. The drone-based audio system of claim 1, wherein the speaker is configured to communication with the user.

7. The drone-based audio system of claim 1, further comprising at least one modular arm removably attached to the drone body, wherein the at least one modular arm comprises at least one motor.

8. The drone-based audio system of claim 7, wherein the at least one modular arm further comprises an arm-based microphone for receiving environmental sound information produced by the at least one motor of the at least one modular arm.

9. The drone-based audio system of claim 8, wherein the at least one modular arm further comprises:
an arm-based speaker for emitting active noise cancellation information; and
an arm-based processing unit configured to analyze the environmental sound information produced by the at least one motor of the at least one modular arm and calculate active noise cancellation information that diminishes the environmental sound information produced by the at least one motor of the at least one modular arm.

10. A method for modifying the sound emitted by a drone in at least one direction, the method comprising:
receiving, with a microphone mounted to a drone, environmental sound information;
calculating, from the environmental sound information, active noise cancellation information; and
emitting, from a speaker mounted to the drone, the active noise cancellation information.

11. The method recited in claim 10 further comprising:
detecting a sound frequency associated with a rotational speed associated with one or more motors;
mechanically adjusting the rotational speed of the one or more motors until the sound frequency reaches a desired range.

12. The method recited in claim 10 further comprising:
detecting with one or more on-board sensors the presence of an audio-reflective surface;
calculating audio-reflection noise cancellation information; and
minimizing reflective noise by emitting the audio-reflection noise cancellation information.

13. The method recited in claim 10 further comprising receiving, at the drone, voice commands from a user.

14. The method as recited in claim 10 further comprising adjusting the directional sound output of the drone.

15. The method for modifying the sound emitted by a drone of claim 14, the method further comprising sensing where the user is located and adjusting sound output of the drone away from the user.

16. A drone-based audio system comprising:
a drone body;
one or more motors attached to the drone body;
a microphone attached to the drone body for receiving environmental sound information; and
a processing unit attached to the drone body configured to:
analyze environmental sound information, and
calculate active noise cancellation information based on the environmental sound information.

17. The drone-based audio system of claim 16, further comprising a speaker attached to the drone body for emitting active noise cancellation information.

18. The drone-based audio system of claim 17, wherein the speaker is further configured to communicate to a user.

19. The drone-based audio system of claim 16, wherein the environmental sound information received from the microphone is a voice command of the user.

20. The drone-based audio system of claim 16, further comprising a shield attached to the drone body configured to directionally adjust sound output of the drone.
